(19) United States
(12) Patent Application Publication
(10) Pub. No.: US 2009/0106750 A1
(43) Pub. Date: Apr. 23, 2009

(54) Method and system for updating a multilayer application

(76) Inventors: Andreas Siwick, Erlangen (DE); Hans-Martin Von Stockhausen, Erlangen (DE)

Correspondence Address: HARNESS, DICKEY & PIERCE, P.L.C., P.O.BOX 8910, RESTON, VA, 20195, US

(21) Appl. No.: 12/285,922

(22) Filed: Oct. 16, 2008

(30) Foreign Application Priority Data
Oct. 18, 2007 (DE) 10 2007 049 958.4

(51) Int. Cl. G06F 9/44

(52) U.S. Cl. 717/168

(57) ABSTRACT

A method is disclosed for updating an application in a data processing system. In at least one embodiment, the method includes providing an application of multilayer design in the data processing system, wherein the application has a plurality of modules which are respectively associated with one of a plurality of hierarchy levels. Further, updated modules which are respectively provided for replacing an existing module are provided. In at least one embodiment of the method, the existing modules are automatically checked to determine whether an associated updated module has been provided and those modules for which updated modules are present are renewed, while the other modules are retained unchanged.

### PRIORITY STATEMENT

The present application hereby claims priority under 35 U.S.C. §119 on German patent application number DE 10 2007 049 958.4 filed Oct. 18, 2007, the entire contents of which is hereby incorporated herein by reference.

### FIELD

Embodiments of the invention generally relate to a method and/or a system for managing multilayer data processing processes, particularly in medical engineering.

### BACKGROUND

DE 103 51 351 A1 discloses a method and a system for dynamically generating user interfaces. This method provides for user interfaces to be generated independently of platform and to be able to be changed dynamically and configured remotely. This is intended to keep down the programming and maintenance complexity in comparison with older systems.

Data processing programs, for example in medical engineering, are frequently required to be able to be used as universally as possible, both as far as the hardware configuration and as far as the software configuration are concerned. In the case of applications which are used in a data processing network, it is typically necessary, depending on the architecture of the target environment, to load and install particular components of the application on a local computer and other components on remote computers.

In an extreme case, full installation, the whole application is loaded and installed on the local computer, what is known as the application client. In the case of a multilayer application, the software to be installed comprises a presentation layer, a business layer and a service layer, for example. Full installation, which allows the entire software to be operated on the application client, presupposes that the latter has sufficient hardware resources.

Unlike full installation, partial installation involves only a subset of the layers needed overall for use of the application being installed on the application client, while the other layers are loaded and installed on remote data processing appliances, for example what are known as application and service servers. In comparison with full installation, partial installation places lower demands on the hardware equipment of an application client.

Whereas, in the case of full installation of an application, only the application client is affected when the software is updated, partial installation sometimes requires software components on different computers to be updated in co-ordinated fashion.

### SUMMARY

In at least one embodiment of the invention, the management of multilayer data processing processes is developed, particularly in medical engineering, further in terms of updatability in comparison with the prior art.

At least one embodiment of the invention is direct to a method and/or by means of a data processing system. In the text which follows, refinements and advantages of embodiments of the invention which are explained in connection with the method also apply mutatis mutandis to the data processing system, and vice versa.

The starting point for at least one embodiment of the method is an application of multilayer design which is provided in a data processing system, particularly in a medical environment. By way of example, individual layers of the application are a presentation layer, a business layer and a service layer. Equally, in individual cases, it may be feasible to assign the infrastructure, data management and image processing to different layers. Each layer of the application has at least one associated module. Overall, the application thus has at least two modules.

To be able to update the software, that is to say the application, without replacing it completely, updated modules are provided which are respectively provided for replacing an existing module. At least one embodiment of the method involves the existing modules being automatically checked to determine whether an associated updated module has been provided. On the basis of this information, those modules for which updated modules are present are, finally, renewed, the other modules remaining unchanged or merely being modified to the extent necessary for interaction with the updated modules.

In a simple case, the update may affect only modules on a single layer, also referred to as a hierarchy level. When the extent of the update is minimal, only a single module on a particular layer of the application is replaced, while other modules which may be present on the same layer and the modules associated with all other layers are not altered. In more complex cases, on the other hand, different updated modules are associated with various hierarchy levels. This may apply in cases in which there are only two hierarchy levels and hence the minimum number of layers is present. Preferably, however, the update method is used for applications which comprise more than two hierarchy levels.

In one advantageous refinement of at least one embodiment, the method is suitable for updating an application which has at least one module which is linked directly to a plurality of further modules on various hierarchy levels.

In line with one example development of at least one embodiment, an updated module is installed in addition to an existing, also usable module, wherein the updated module is linked directly to a first present module and the existing module is linked directly to a second present module.

The update therefore increases the number of usable modules. In this case, provision may be made for the first present module to be modified automatically in the course of the installation of the updated module in order to render it usable within the changed structure of the application, while the second present module remains unchanged. The different modules present, only some of which require modification in the course of the application being updated, may belong to various hierarchy levels.

Regardless of the precise embodiment, the method of at least one embodiment can be performed by way of a computer program product, with a computer-readable medium prompting the computer to carry out the method. In this case, the program is not necessarily stored on a single medium, but rather may be stored, having been divided into function blocks, in a plurality of memories at separate locations from one another, for example.

The advantage of at least one embodiment of the invention is particularly that a software management service which is extremely convenient to handle is provided which allows applications on application clients to be updated with the greatest degree of automation. In this case, an application may be designed from logically and physically separate chips, what are known as modules. The user using the method according to at least one embodiment of the invention does not need to have any information regarding which modules on which layers of the application need to be updated in the specific case. Rather, the application itself carries this information. In all cases, it is certain that the update covers only the modules which actually need to be changed. Beyond the high level of convenience for use, the result of this is that the update is performed in a very time-saving manner. The interaction of the user during the update is usually limited to simple confirmation. At the same time, the user is provided with the opportunity to display detail information about the update, so that the desired transparency is always provided.

One particular advantage is the opportunity provided for the user to determine the scope of the update himself. By way of example, the user can stipulate that only some of the modules of the application need to be updated, while the other modules continue to be operated in older versions. Considered overall, this means that different modules of the application may have various life cycles, which may be appropriate in view of the different functions of the individual modules and makes a crucial contribution to particularly rational maintainability of the application.

### BRIEF DESCRIPTION OF THE DRAWINGS

Several variants of the method according to embodiments of the invention and a data processing system suitable for carrying out the method are explained in more detail below with reference to a drawing, in which:

FIG. 1 shows a symbolized illustration of a data processing system,

FIG. 2 shows the basic structure of a first multilayer application which can be used within the data processing system shown in FIG. 1,

FIG. 3 shows an illustration similar to FIG. 2 of a second example embodiment of a multilayer application,

FIG. 4 shows a first variant of an update for the application shown in FIG. 2,

FIG. 5 shows a second variant of an update for the application shown in FIG. 2, and

FIG. 6 shows various options for updates for an application in graph form.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

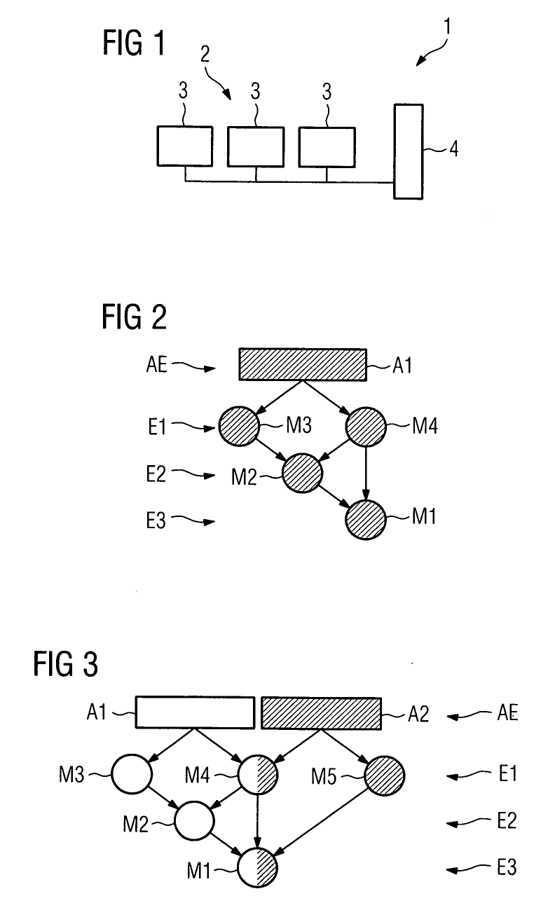

A data processing system 1 shown in highly schematic form in FIG. 1 includes a data recording system 2, which has a plurality of data recording units 3, and also a data processing unit 4 which is connected for data processing purposes, particularly via a network, to the data recording system 2. By way of example, the data recording units 3 may be what are known as modalities in medical engineering, particularly imaging diagnostic appliances such as computer tomographs or magnetic resonance appliances.

The data processing unit 4, which is not necessarily, as shown in simplified form in FIG. 1, available in the form of a single computer but rather may also be implemented as a more complex data processing network comprising a plurality of individual appliances, for example, is designed to carry out an application which processes data obtained directly or indirectly with the data recording system 2, that is to say medical data.

The basic structure of a first example embodiment of an application is illustrated in FIG. 2. This is an application A1 which is of multilayer design, with three levels E1, E2, E3 which contain modules M1, M2, M3, M4 and with an application level AE. Overall, the application therefore has four hierarchy levels AE, E1, E2, E3. The level E1 has the modules M3 and M4 associated with it, while the module M2 is associated with the level E2 and the module M1 is associated with the level E3. The module M1 is linked directly to different modules on various hierarchy levels, namely firstly to the module M2 on level E2 and secondly to the module M4 on level E1. The modules M3, M4 associated with the level E1, which is directly beneath the application level AE, are referred to as directly required modules, while the modules M1, M2, which are linked to the application level AE only indirectly, are referred to as indirectly required modules.

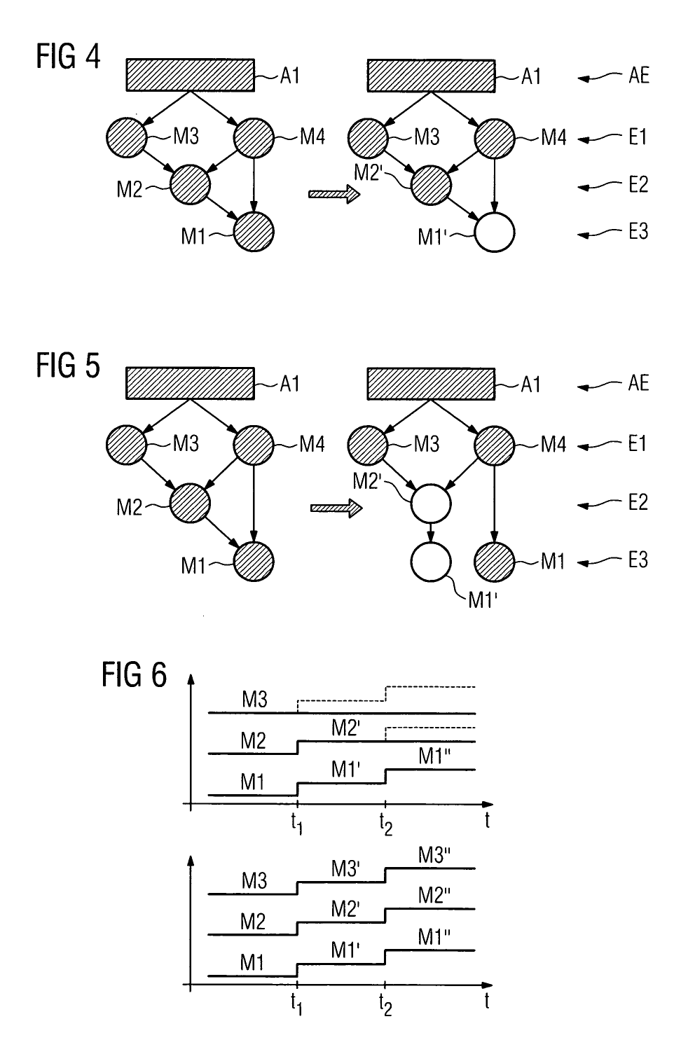

On the basis of the prior art, an isolated update for the indirectly required modules M1, M2 would presuppose that first of all a direct reference is set up between these modules M1, M2 and the application level AE. This means that for the purpose of the update the four-level modular application A1 would first of all need to be converted into a two-level application which comprises only the application level AE and a single further level containing all the modules M1, M2, M3, M4. The invention serves to avoid the associated complexity, as will be explained in more detail below with reference to FIGS. 4 and 5.

A more complex application in comparison with the example embodiment shown in FIG. 2 and one that is likewise intended for an update based on the method according to an embodiment of the invention is shown in FIG. 3. In this case, two applications A1, A2 are placed next to one another on the application level AE so as to be hierarchically equivalent. The two applications A1, A2 at least to some extent access the same modules, namely the modules M3, M4, M5 on the level E1, the module M2 on the level E2, and the module M1 on the level E3. In a similar manner to in the example embodiment shown in FIG. 2, the modules M1, M2 are indirectly required modules, while in the present case there are a total of three directly required modules M3, M4, M5.

Both in the example embodiment shown in FIG. 2 and in the example embodiment shown in FIG. 3, all the modules M1, M2, M3, M4 (and possibly M5) may be software applications finished at different times, so that each application A1, A2 can be referred to overall as an evolutionary software system which, in the specific case, may have significantly more than three levels E1, E2, E3. By way of example, infrastructure, data management and image processing, that is to say the processing of medical image data recorded using the data recording units 3, particularly layer recordings, are associated with various hierarchy levels E1, E2, E3. The different modules M1, M2, M3, M4, M5 of the applications A1, A2 may be separate from one another not only logically but also physically, for example stored on different computers, for example in some cases on application computers and in some cases on application or service servers.

For the purpose of selectively updating individual modules M1, M2, M3, M4, M5 of an application A1, A2, there are two different variants of the inventive method available, namely firstly what is known as a patch and secondly what is known as an upgrade, which are explained below with reference to FIG. 4 and with reference to FIG. 5. In this case, both in FIG. 4 and in FIG. 5, the left-hand half of the respective illustration shows the structure of the application before the update, while the right-hand half of the illustration visualizes the structure after the update, that is to say after the patch or after the upgrade.

In the case of the patch (FIG. 4), a module, in the present case the module M1, is updated, with the effects of the update being limited to the updated module. The module replacing the original module M1 is referred to as the updated module M1′. In the same way as the modules M2, M4 use the original module M1, the updated module M1′ is used by the modules M2, M4, without these requiring any change.

In the example embodiment shown in FIG. 5, which illustrates an upgrade, the initial situation is identical to the initial situation in the example embodiment shown in FIG. 4. Unlike in this case, however, the update affects a plurality of modules:

First of all, the module M1 associated with the level E3, that is to say the lowest hierarchy level, is updated, so that as a result of the update it is possible to use the updated module M1′. Unlike in the example embodiment shown in FIG. 4, however, the update, which primarily affects the module M1, affects the module M2, which is associated with the next highest hierarchy level E2 and which accesses the module M1. It is therefore also necessary to update the module M2, namely to replace it with an updated module M2′. This update is performed within the upgrade in the form of a patch, which manifests itself in that the modules M3, M4, which are associated with the level E1 and which access the module M2, do not need to be changed, despite the latter having been updated.

One particular feature of the method variant shown in FIG. 5 is also that besides the updated module M1′ the original version of the relevant module, that is to say the module M1, also remains active. As can be seen from FIG. 5, not only the module M2 but also the module M4 accesses the module M1 directly. As far as the direct access by the module M4 is concerned, however, no update is desired, unlike in the case of the access by the module M2. Rather, the intention is that the module M4, in so far as there is direct coupling to the module M1, performs its functions in identical fashion before and after the update. This is achieved by virtue of the original module M1 being retained so as to be hierarchically equivalent beside the updated module M1′, and a further link being produced. Hence, depending on requirements, it is possible for different software levels to coexist within a complex software system, which particularly implies advantages in terms of the complexity for maintaining the software system.

The simple option of using software modules at different development levels in parallel within a complex software system is explained below with reference to a graph which is shown in FIG. 6.

Let us first assume that an application A1 with the modules M1, M2, M3 is available. At the time t₁, an updated version M1′, M2′, M3′ is provided for each module M1, M2, M3. The change to a new development level, that is to say an updated version M1′, M2′, M3′, is indicated symbolically in the bottom part of FIG. 6 by a step in the relevant curve. A further update at the time t₂ leads from the versions M1′, M2′, M3′ to the modules M1″, M2″, M3″. The bottom part of the illustration in FIG. 6 therefore shows the gradual update of the application A1 to the greatest possible extent in each case.

In practice, it may be expedient to ignore the greatest possible scope of update in the individual case and to update only those software components for which such a change promises a benefit which is favorably related to the complexity and risk of the update. Such a scenario is illustrated in the top part of the graph shown in FIG. 6. The first module M1 is updated both at the time t₁ and at the time t₂ and is therefore always kept up to date. In the case of the second module M2, on the other hand, only the update at the time t₁ is performed, ignoring the possible update at the time t₂. The update which is possible, in principle, but is not performed is indicated by a dashed line. A similar situation applies to the third module M3, which continues to be used without any update. From the time t₂ onward, modules M1″, M2′, M3 at three different development levels are therefore used in parallel.

The text below presents extracts from a program for carrying out the method according to an embodiment of the invention.

First of all, a software component called “DeploymentService” checks the availability of updated application parts on the server, the available updates being returned as a graph of “DeploymentTasks”:

```
public class DeploymentService: IDeploymentService
{
  // Checks for available updates on the deployment
  server public IDeploymentTask CheckForUpdates (Uri
  manifestUri)
  {
    try
    {
      //reference to a hierarchical graph of
      //manifests
      ManifestNode manifestNode = null
      //check whether updates are available
      myUpdater.CheckForUpdates(
        manifestUri, out manifestNode);
      //add missing and remove superfluous
      //manifests
      myManifestCache.AddRemoveManifests(
        ref ManifestNode);
      //convert the graph of manifests to an
      //array in order to get the number of
      //different manifests in the graph
      manifestsCount=manifestNode.ConvertGraphToList( ).-
      ToArray( ).Length;
      //check whether updates are available
      if (manifestsCount > 0)
      {
        //create and return DeploymentTasks
        return DeploymentTasks.CreateDeploymentTasks (
          myApplicationName,
          null,
          myUpdater,
          manifestNode
        );
      }
      else
      {
        return null;
      }
    }
    catch (Exception anException)
    {
      // error handling
      ...
    }
  }
}
```

To allow the user to use the updates found, they are first of all downloaded asynchronously and are then activated asynchronously, that is to say installed:

```
public class DeploymentTask : IDeploymentTask, IDisposable
{
  internal static DeploymentTask CreateDeploymentTasks(
    string applicationName,
    DeploymentTask parentNode,
    ApplicationUpdaterManager updater,
    ManifestNode manifestNode)
  {
    //create DeploymentTask for parent node
    DeploymentTask aDeploymentTask = DeploymentTask.-
    CreateDeploymentTask(
        applicationName, parentNode, updater,
        manifestNode
      );
    //recursively call CreateDeploymentTasks for all
    //child nodes
    for (int i = 0; i < manifestNode.ChildNodesCount;
    i++)
    {
        DeploymentTask.Create DeploymentTask(
          applicationName, aDeploymentTask,
          updater, manifestNode[i]
      );
    }
    return aDeploymentTask;
  }
  private static DeploymentTask CreateDeploymentTask(
    string applicationName,
    DeploymentTask parentNode,
    ApplicationUpdaterManager updater,
    ManifestNode manifestNode)
{
    DeploymentTask aDeploymentTask = null;
    string manifestGuid = manifestNode.Manifest.Manifest
    Id.ToString( );
    // check whether the current DeploymentTask is not a
root
    // node in the graph
    if (parentNode != null)
    {
      // check whether the current DeploymentTask
      // already exists in the graph
      if (parentNode.myGraphNodes.ContainsKey(manifest-
      Guid))
      {
        aDeploymentTask =
        parentNode.myGraphNodes[manifestGuid];
      }
      else
      {
        // create new deploymentTask
        aDeploymentTask = new DeploymentTask(
          applicationName, updater,
          manifestNode);
        aDeploymentTask.myGraphNodes = parentNode.my-
        GraphNodes;
        aDeploymentTask.myGraphNodes.Add(
          manifestGuid, aDeploymentTask);
      }
      parentNode.myDeploymentTasks.Add(
        aDeploymentTask);
  }
  else
  {
  // create new deploymentTask
  aDeploymentTask = new DeploymentTask(
      applicationName, updater, manifestNode);
      aDeployment-
      Task.myGraphNodes = new Dictionary<string, DeploymentTask>( );
      aDeploymentTask.myGraphNodes.Add(
        manifestGuid, aDeploymentTask);
  }
  // increment the reference counter
  aDeploymentTask.myReferenceCount++;
  return aDeploymentTask;
}
public void BeginDownload( )
{
  try
  {
    // start asynchronous download
    myUpdater.BeginDownload(myManifestNode.Convert-
    GraphToList( ).ToArray( ));
  }
  catch (ApplicationUpdaterException anException)
  {
    throw new DeploymentServiceException (“Failed to begin
    download.”, anException);
  }
}
public void CancelDownload( )
{
  try
  {
      // cancel download of this deploymentTask
      myUpdater.CancelDownload(myManifestNode.Manifest);
      // cancel download of all descendant
      // DeploymentTasks
      Manifest[ ] manifests = myManifestNode.ConvertGraph-
      ToList( ).ToArray( );
      foreach (Manifest aManifest in Manifests)
      {
  myUpdater.CancelDownload(aManifest);
      }
  }
  catch (ApplicationUpdaterException anException)
  {
      throw new DeploymentServiceException(“Failed to cancel
      download.”, anException);
  }
}
public void BeginActivate( )
{
  try
  {
      myActivationContext = myUpdater.BeginActivate(
        myManifestNode.ConvertGraphToList( ).ToArray( );
      );
  }
  catch (ApplicationUpdaterException anException)
  {
      throw new DeploymentServiceException(“Failed to begin
      activation.”, anException);
  }
}
public void CancelActivate( )
{
  try
  {
    // cancel activation of this DeploymentTask
    myUpdater.CancelActivate(myActivationContext);
  }
  catch (ApplicationUpdaterException exception)
  {
    throw new DeploymentServiceException(“Failed to cancel
    activation.”, exception);
  }
}
public bool IsDownloadStarted( )
{
  lock (DeploymentTask.myMutex)
  {
    bool downloadStarted = false;
    //check if this DeploymentTask or one of its
    //children reports DownloadStarted
    //then DownloadStarted is true
    foreach (DeploymentTask aDeploymentTask in this.ConvertGraphToList( ))
  {
    if (this.GetDescendantOrSelf(aDeploymentTask.Manifst.-
    Guid) !=null)
    {
      downloadStarted = downloadStarted || aDeploymentTask.-
      mydownloadStarted;
    }
      }
      return downloadStarted;
  }
}
public bool IsDownloadCompleted( )
{
  lock (DeploymentTask.myMutex)
    {
    bool downloadCompleted = true;
    // check if this DeploymentTask and all its
    // children reports DownloadCompleted
    // then DownloadCompleted is true
    foreach (DeploymentTask aDeploymentTask in this.ConvertGraphToList( ))
    {
      if (this.GetDescendantOrSelf(aDeploymentTask.Manifst.-
      Guid) !=null)
      {
        downloadCompleted -
        downloadCompleted && aDeployment
        Task.my downloadCompleted;
      }
    }
    return downloadCompleted;
  }
}
public bool IsActivationStarted( )
{
  lock (DeploymentTask.myMutex)
  {
    bool activationStarted = false;
    // check if this DeploymentTask or one of its
    // children reports ActivationStarted
    // then ActivationStarted is true
    foreach (DeploymentTask aDeploymentTask in this.ConvertGraphToList( ))
    {
      if (this.GetDescendantOrSelf(aDeploymentTask.Manifst.-
        Guid) !=null)
        {
          activation-
          Started = activationStarted || aDeployment
          Task.myactivationStarted;
        }
      }
      return activationStarted;
  }
}
public bool IsActivationCompleted( )
{
  lock (DeploymentTask.myMutex)
  {
    bool activationCompleted = true;
    // check if this DeploymentTask and all its
    // children reports ActivationCompleted
    // then activationCompleted is true
    foreach (DeploymentTask aDeploymentTask in this.ConvertGraphToList( ))
    {
        if (this.GetDescendantOrSelf(aDeploymentTask.Manifst.-
        Guid) != null)
        {
          activationCompleted =
          activationCompleted && aDeployment
          Task.myactivationCompleted;
        }
    }
    return activationCompleted;
  }
  }
}
...
```

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for updating an application in a data processing system, comprising:
providing an application of multilayer design in the data processing system, the application including a plurality of modules which are respectively associated with one of a plurality of hierarchy levels;
providing updated modules which are respectively provided for replacing an existing module;
automatically checking the existing modules to determine whether an associated updated module has been provided; and
renewing modules determined to have updated provided, while retaining the other modules as unchanged.

2. The method as claimed in claim 1, wherein the updated modules are associated with various hierarchy levels.

3. The method as claimed in claim 1, wherein the application includes more than two hierarchy levels.

4. The method as claimed in claim 3, wherein the application includes a presentation layer, a business layer and a service layer.

5. The method as claimed in claim 3, wherein the application includes a module which is linked directly to a plurality of modules on various hierarchy levels.

6. The method as claimed in claim 1, wherein an updated module is installed in addition to an existing, also usable module, and wherein the updated module is linked directly to a first present module and the existing module is linked directly to a second present module.

7. The method as claimed in claim 6, wherein the first present module is modified in the course of the installation of the updated module, while the second present module remains unchanged.

8. The method as claimed in claim 6, wherein the different present modules belong to various hierarchy levels.

9. A system for managing multilayer data processing processes, comprising:
a data recording system; and
a data processing unit to process data acquired using the data recording system, an application of multilayer design being provided in the data processing system, the application including a plurality of modules which are respectively associated with one of a plurality of hierarchy levels, and updated modules being provided which are respectively provided for replacing an existing module, the data processing unit being useable to,
automatically check the existing modules to determine whether an associated updated module has been provided, and
renew modules determined to have updated provided, while retaining the other modules as unchanged.

10. The system as claimed in claim 9, wherein the data recording system is a medicotechnical data recording system.

11. The method as claimed in claim 2, wherein the application includes more than two hierarchy levels.

12. The method as claimed in claim 11, wherein the application includes a presentation layer, a business layer and a service layer.

13. The method as claimed in claim 7, wherein the different present modules belong to various hierarchy levels.

14. A computer readable medium including program segments for, when executed on a computer device, causing the computer device to implement the method of claim 1.
